(19) United States
(12) Patent Application Publication
(10) Pub. No.: US 2024/0286910 A1
(43) Pub. Date: Aug. 29, 2024

(54) Borate Microwave Dielectric Ceramic with Low Dielectric Constant, and Preparation Method Thereof by Cold Sintering

(71) Applicant: QILU UNIVERSITY OF TECHNOLOGY (SHANDONG ACADEMY OF SCIENCES), Jinan (CN)

(72) Inventors: Feng Shi, Jinan (CN); Fuzhou Song, Jinan (CN); Xiangyu Wang, Jinan (CN); Shuai LV, Jinan (CN); Yue Xu, Jinan (CN); Lingcui Zhang, Jinan (CN); Yan Shen, Jinan (CN); Jinbo Zhao, Jinan (CN)

(21) Appl. No.: 18/586,638

(22) Filed: Feb. 26, 2024

(30) Foreign Application Priority Data
Feb. 28, 2023 (CN) 2023101714493

(51) Int. Cl. C01B 35/12; H01B 3/12

(52) U.S. Cl. CPC C01B 35/126; H01B 3/12; C01P 2002/72; C01P 2002/77; C01P 2004/03; C01P 2006/40

(57) ABSTRACT

Disclosed are a borate MWDC with a low dielectric constant and a preparation method thereof by cold sintering. The method for preparing a borate MWDC with a low dielectric constant by cold sintering, including: subjecting a boron source and a metal source to first mixing to obtain a first mixture; subjecting the first mixture to presintering to obtain a presintered material; subjecting the presintered material and a boron oxide solution to second mixing to obtain a second mixture; and subjecting the second mixture to cold sintering to obtain the borate MWDC with the low dielectric constant.

### CROSS REFERENCE TO RELATED APPLICATION

This patent application claims the benefit and priority of Chinese Patent Application No. 2023101714493 filed with the China National Intellectual Property Administration on Feb. 28, 2023, the disclosure of which is incorporated by reference herein in its entirety as part of the present application.

### TECHNICAL FIELD

The present disclosure belongs to the technical field of microwave dielectric ceramics (MWDCs), and specifically relates to a borate MWDC with a low dielectric constant and a preparation method thereof by cold sintering.

### BACKGROUND

Due to rapid data transmission, low network latency, and strong device connectivity, 5G communication technology is becoming a main development direction of the Internet of Things, artificial intelligence, radar, navigation, and military applications. MWDCs are widely used in manufacturing of electronic components such as resonators, antenna substrates, and filters in communication systems. At present, miniaturization and integration of microwave devices are the direction and trend of development, and the development of advanced wireless communication technology represented by 5G has put forward higher and newer requirements for the performance of MWDCs. Therefore, MWDCs are required with a low dielectric constant (εᵣ<15), a high-quality factor (Q×f), and a near-zero temperature coefficient of resonance frequency (τ_{f}).

Borate MWDCs have excellent dielectric properties, such as the low dielectric constant and high-quality factor, making it an ideal candidate material for 5G communication applications. Traditionally, the borate MWDCs are mainly prepared by high-temperature solid-phase synthesis. However, borates would be decomposed and evaporated at high temperature (1,300° C. to 1,500° C.), which could easily lead to the loss of volatile elements or the introduction of second-phase impurities, causing a reduction in dielectric properties.

### SUMMARY

An object of the present disclosure is to provide a borate MWDC with a low dielectric constant, and a preparation method thereof by cold sintering. In the present disclosure, the borate MWDC prepared by the preparation method exhibits excellent dielectric properties.

To achieve the above object, the present disclosure provides the following technical solutions:

The present disclosure provides a method for preparing a borate MWDC with a low dielectric constant by cold sintering, including:
subjecting a boron source and a metal source to first mixing to obtain a first mixture, and subjecting the first mixture to presintering to obtain a presintered material; and
subjecting the presintered material and a boron oxide solution to second mixing to obtain a second mixture, and subjecting the second mixture to cold sintering to obtain the borate MWDC with the low dielectric constant.

In some embodiments, the boron source is one or two selected from the group consisting of boron oxide and boric acid; and

a metal element in the metal source is one or more selected from the group consisting of calcium, barium, and strontium.

In some embodiments, a molar ratio of the boron source to the metal source is in a range of 1:2.5 to 1:3.

In some embodiments, the first mixing is conducted by ball milling; and

the ball milling is conducted at a speed of 380 r/min to 400 r/min for 6 h to 8 h.

In some embodiments, the presintering is conducted at a temperature of 1,000° C. to 1,050° C. for 8 h to 10 h.

In some embodiments, the boron oxide solution has a mass concentration of 2.5% to 3.8%; and
a mass ratio of the presintered material to the boron oxide solution is in a range of 1:1 to 2:1.

In some embodiments, the method further includes: subjecting the presintered material to wet ball milling, drying, and sieving in sequence before the second mixing;
where the wet ball milling is conducted at a speed of 380 r/min to 400 r/min for 6 h to 8 h.

In some embodiments, the cold sintering is conducted at a temperature of 285° C. to 300° C. for 20 min to 30 min under 100 MPa to 800 MPa.

In some embodiments, the method further includes: after the cold sintering, subjecting a resulting material to annealing;
where the annealing is conducted at a temperature of 800° C. to 850° C. for 3 h to 6 h.

The present disclosure further provides a borate MWDC with a low dielectric constant prepared by the method described above, where the borate MWDC has a dielectric constant of 4.42 to 6.88;
the borate MWDC has a quality factor of 6,737 GHz to 15,563 GHz; and
the borate MWDC has a temperature coefficient of resonance frequency of −28.62 ppm·° C.⁻¹ to −15.98 ppm·° C.⁻¹.

The present disclosure provides a method for preparing a borate MWDC with a low dielectric constant by cold sintering, including: subjecting a boron source and a metal source to first mixing to obtain a first mixture; subjecting the first mixture to presintering to obtain a presintered material; subjecting the presintered material and a boron oxide solution to second mixing to obtain a second mixture; and subjecting the second mixture to cold sintering to obtain the borate MWDC with the low dielectric constant. In the present disclosure, through the cold sintering, an abnormal growth of ceramic grains during the sintering could be inhibited, a loss of volatile elements during the sintering could also be prevented, and a shrinkage rate during densification of the ceramic could be better controlled, thereby improving dielectric properties of the MWDC. In addition, the cold sintering is conducted at a low sintering temperature which could reduce energy consumption, and has relatively simple preparation requirements, making it suitable for industrial production.

### BRIEF DESCRIPTION OF THE DRAWINGS

FIG. 1 shows an X-ray diffraction (XRD) pattern of the borate MWDCs obtained in Examples 1 to 5;

FIG. 2 shows a crystal structure of the borate MWDC obtained in Example 5;

FIG. 3A shows a temperature coefficient of resonant frequency of the borate MWDCs obtained in Examples 1 to 5;

FIG. 3B shows a quality factor of the borate MWDCs obtained in Examples 1 to 5;

FIG. 3C shows a dielectric constant of the borate MWDCs obtained in Examples 1 to 5;

FIG. 4A shows a scanning electron microscopy (SEM) image of the borate MWDCs obtained in Examples 1 to 5 under 100 MPa;

FIG. 4B shows a scanning electron microscopy (SEM) image of the borate MWDCs obtained in Examples 1 to 5 under 200 MPa;

FIG. 4C shows a scanning electron microscopy (SEM) image of the borate MWDCs obtained in Examples 1 to 5 under 400 MPa;

FIG. 4D shows a scanning electron microscopy (SEM) image of the borate MWDCs obtained in Examples 1 to 5 under 600 MPa;

FIG. 4E shows a scanning electron microscopy (SEM) image of the borate MWDCs obtained in Examples 1 to 5 under 800 MPa; and

FIG. 5 shows a synthesis route diagram according to an embodiment of the present disclosure.

### DETAILED DESCRIPTION OF THE EMBODIMENTS

The present disclosure provides a method for preparing a borate MWDC with a low dielectric constant by cold sintering, including:
subjecting a boron source and a metal source to first mixing to obtain a first mixture, and subjecting the first mixture to presintering to obtain a presintered material; and
subjecting the presintered material and a boron oxide solution to second mixing to obtain a second mixture, and subjecting the second mixture to cold sintering to obtain the borate MWDC with the low dielectric constant.

In the present disclosure, unless otherwise specified, all raw materials are commercially available products well known to those skilled in the art.

In the present disclosure, a boron source and a metal source are subjected to first mixing to obtain a first mixture; and the first mixture is subjected to presintering to obtain a presintered material.

In the present disclosure, the boron source is one or two selected from the group consisting of boron oxide and boric acid. In some embodiments, the boron oxide has a purity of 98%.

In some embodiments, a metal element in the metal source is one or more selected from the group consisting of calcium, barium, and strontium. In some embodiments, the metal source is one or two selected from the group consisting of carbonates and metal oxides. In some embodiments, the metal source is calcium carbonate. In some embodiments, the calcium carbonate has a purity of 99%.

In some embodiments, a molar ratio of the boron source to the metal source is in a range of 1:2.5 to 1:3.

In some embodiments, the boron source and the metal source are dried before the first mixing. There is no special limitation on the drying, and a drying process well known to those skilled in the art may be used.

In some embodiments, the first mixing is conducted by ball milling; and the ball milling is conducted at a speed of 380 r/min to 400 r/min for 6 h to 8 h.

In some embodiments, the ball milling is conducted by wet ball milling, and a dispersion medium used in the wet ball milling is absolute ethanol. In some embodiments, grinding balls used in the wet ball milling are zirconia balls, and the zirconia balls have a diameter of 1.4 mm to 1.6 mm. In some embodiments, a mass ratio of a total mass of the boron source and the metal source, the zirconia balls, and the absolute ethanol is 1:3:2.5. In some embodiments, the ball milling is conducted in a ball mill.

In some embodiments, after the ball milling, a resulting material is subjected to drying and sieving in sequence. In some embodiments, the drying is conducted at a temperature of 80° C. There is no special limitation on a drying time, and any drying time may be used as long as the resulting material could be dried to a constant weight at the above drying temperature. In some embodiments, the drying is conducted in an oven.

In some embodiments, a sieve mesh for the sieving has a pore size of 80 mesh. There is no special limitation on the sieving, and a sieving process well known to those skilled in the art may be used.

In some embodiments, the presintering is conducted at a temperature of 1,000° C. to 1,050° C. In some embodiments, the first mixture is heated to the presintering temperature at a heating rate of 3° C./min to 5° C./min. In some embodiments, the presintering is conducted for 8 h to 10 h. In some embodiments, the presintering is conducted in an air atmosphere. In some embodiments, the presintering is conducted in a high-temperature sintering furnace.

In the present disclosure, after the presintering, a presintered material is obtained. The presintered material and a boron oxide solution are subjected to second mixing to obtain a second mixture, and the second mixture is subjected to cold sintering to obtain the borate MWDC with the low dielectric constant.

In some embodiments, the boron oxide solution has a mass concentration of 2.5% to 3.8%. In some embodiments, a mass ratio of the presintered material to the boron oxide solution is in a range of 1:1 to 2:1.

In some embodiments, the boron oxide solution is added in the form of a saturated boron oxide solution, and the saturated boron oxide solution has a mass concentration of 3.8%.

In some embodiments, the presintered material is subjected to wet ball milling, drying, and sieving in sequence before the second mixing. In some embodiments, a dispersion medium of the wet ball milling is absolute ethanol. In some embodiments, grinding balls used in the wet ball milling are zirconia balls, and the zirconia balls have a diameter of 1.4 mm to 1.6 mm. In some embodiments, a mass ratio of the presintered material, the zirconia balls, and the absolute ethanol is 1:3:2.5. In some embodiments, the ball milling is conducted in a ball mill. In some embodiments, the drying is conducted at a temperature of 80° C. There is no special limitation on a drying time, and any drying time may be used as long as the presintered material could be dried to a constant weight at the above drying temperature. In some embodiments, a sieve mesh for the sieving has a pore size of 80 mesh. There is no special limitation on the sieving, and a sieving process well known to those skilled in the art may be used.

In some embodiments, the second mixing is conducted by grinding. There is no special limitation on the grinding, and any grinding process well known to those skilled in the art may be used. In some embodiments, the grinding is conducted in a mortar.

In some embodiments, the cold sintering is conducted at a temperature of 285° C. to 300° C., preferably 288° C. to 298° C., and more preferably 290° C. to 295° C. In some embodiments, the cold sintering is conducted for 20 min to 30 min, preferably 22 min to 28 min, and more preferably 25 min to 26 min. In some embodiments, the cold sintering is conducted under a pressure of 100 MPa to 800 MPa, preferably 200 MPa to 700 MPa, and more preferably 300 MPa to 600 MPa.

In the present invention, the cold sintering is conducted by a process including:
adding the second mixture in a mold, placing the mold in a hot press, and performing the cold sintering.

In some embodiments, the mold is a cylindrical mold. There is no special limitation on a size of the mold, and any size well known to those skilled in the art may be used.

In the present disclosure, after the cold sintering, a resulting material is subjected to annealing. In some embodiments, the annealing is conducted at a temperature of 800° C. to 850° C. for 3 h to 6 h. In some embodiments, the annealing is conducted in an air atmosphere.

In some embodiments, after the annealing, a resulting material is cooled. In some embodiments, the cooling is conducted by natural cooling until the resulting material is cooled to room temperature.

In some embodiments, an obtained cooled material is ground and polished after the cooling is completed. There is no special limitation on a grinding and polishing process, which may be conducted by a process well known to those skilled in the art.

In the present disclosure, the cold sintering is conducted at a low sintering temperature which could reduce energy consumption, and has relatively simple preparation requirements. In addition, through the cold sintering, an abnormal growth of ceramic grains during the sintering could be inhibited, a loss of volatile elements during the sintering could also be prevented, and a shrinkage rate of 6% to 10% during densification of the ceramic could be better controlled, thereby improving dielectric properties of the MWDC.

The present disclosure further provides a borate MWDC with a constant prepared by the method described above, where the borate MWDC has a dielectric constant of 4.42 to 6.88 and a quality factor of 6,737 GHz to 15,563 GHz. In some embodiments, the borate MWDC has a temperature coefficient of resonance frequency of −28.62 ppm·° C.⁻¹ to −15.98 ppm·° C.⁻¹.

In some embodiments, the borate MWDC has a pure phase structure.

In order to further illustrate the present disclosure, the borate MWDC with a low dielectric constant and the preparation method thereof by cold sintering provided by the present disclosure are described in detail below with reference to the accompanying drawings and examples, but the accompanying drawings and the examples should not be construed as limiting the scope of the present disclosure.

### Example 1

0.2 mol of B₂O₃ (purity: 98%) and 0.6 mol of CaCO₃ (purity: 99%) were dried separately and placed in a ball mill. At the same time, zirconia balls (particle size 1.4 mm to 1.6 mm) and absolute ethanol (a mass ratio of a total mass of the B₂O₃ and CaCO₃, the zirconia balls, and the absolute ethanol was 1:3:2.5) were added into the ball mill. Then, the resulting system was subjected to wet ball milling at 400 r/min for 6 h. A resulting slurry was dried in an oven at 80° C. to a constant weight, and sieved through a sieve with a pore size of 80 mesh to collect a sieved material below the sieve. The sieved material was placed into a high-temperature sintering furnace, heated to a temperature of 1,000° C. at a rate of 3° C./min, and then subjected to presintering at the temperature for 10 h to obtain a presintered material.

The presintered material, zirconia balls (diameter: 1.4 mm to 1.6 mm), and absolute ethanol (a mass ratio of the presintered material, the zirconia balls, and the absolute ethanol was 1:3:2.5) were placed into a ball mill, and subjected to wet ball milling at 400 r/min for 6 h. A resulting slurry was dried in an oven at 80° C. to a constant weight, and sieved through a sieve with a pore size of 80 mesh to collect a sieved presintered material below the sieve.

5 g of the sieved presintered material and 5 g of a saturated boron oxide solution with a mass concentration of 3.8% were mixed evenly by grinding in a mortar, and a resulting slurry was poured into a cylindrical mold. Then, the cylindrical mold was placed into a hot press, and subjected to cold sintering at 100 MPa and 285° C. for 30 min. A resulting ceramic sheet obtained by the cold sintering was annealed at 810° C. for 5 h, and then ground and polished to obtain a borate MWDC.

### Example 2

0.2 mol of B₂O₃ (purity: 98%) and 0.6 mol of CaCO₃ (purity: 99%) were dried separately and placed in a ball mill. At the same time, zirconia balls (particle size 1.4 mm to 1.6 mm) and absolute ethanol (a mass ratio of a total mass of the B₂O₃ and CaCO₃, the zirconia balls, and the absolute ethanol was 1:3:2.5) were added into the ball mill. Then, the resulting system was subjected to wet ball milling at 400 r/min for 6 h. A resulting slurry was dried in an oven at 80° C. to a constant weight, and sieved through a sieve with a pore size of 80 mesh to collect a sieved material below the sieve. The sieved material was placed into a high-temperature sintering furnace, heated to a temperature of 1,000° C. at a rate of 3° C./min, and then subjected to presintering at the temperature for 10 h to obtain a presintered material.

The presintered material, zirconia balls (diameter: 1.4 mm to 1.6 mm), and absolute ethanol (a mass ratio of the presintered material, the zirconia balls, and the absolute ethanol was 1:3:2.5) were placed into a ball mill, and subjected to wet ball milling at 400 r/min for 6 h. A resulting slurry was dried in an oven at 80° C. to a constant weight, and sieved through a sieve with a pore size of 80 mesh to collect a sieved presintered material below the sieve.

5 g of the sieved presintered material and 5 g of a saturated boron oxide solution with a mass concentration of 3.8% were mixed evenly by grinding in a mortar, and a resulting slurry was poured into a cylindrical mold. Then, the cylindrical mold was placed into a hot press, and subjected to cold sintering at 200 MPa and 285° C. for 30 min. A resulting ceramic sheet obtained by the cold sintering was annealed at 820° C. for 4.5 h, and then ground and polished to obtain a borate MWDC.

### Example 3

0.2 mol of B₂O₃ (purity: 98%) and 0.6 mol of CaCO₃ (purity: 99%) were dried separately and placed in a ball mill. At the same time, zirconia balls (particle size 1.4 mm to 1.6 mm) and absolute ethanol (a mass ratio of a total mass of the B₂O₃ and CaCO₃, the zirconia balls, and the absolute ethanol was 1:3:2.5) were added into the ball mill. Then, the resulting system was subjected to wet ball milling at 400 r/min for 6 h. A resulting slurry was dried in an oven at 80° C. to a constant weight, and sieved through a sieve with a pore size of 80 mesh to collect a sieved material below the sieve. The sieved material was placed into a high-temperature sintering furnace, heated to a temperature of 1,000° C. at a rate of 3° C./min, and then subjected to presintering at the temperature for 10 h to obtain a presintered material.

The presintered material, the zirconia balls (diameter: 1.4 mm to 1.6 mm), and absolute ethanol (a mass ratio of the presintered material, the zirconia balls, and the absolute ethanol was 1:3:2.5) were placed into a ball mill, and subjected to wet ball milling at 400 r/min for 6 h. A resulting slurry was dried in an oven at 80° C. to a constant weight, and sieved through a sieve with a pore size of 80 mesh to collect a sieved presintered material below the sieve.

5 g of the sieved presintered material and 5 g of a saturated boron oxide solution with a mass concentration of 3.8% were mixed evenly by grinding in a mortar, and a resulting slurry was poured into a cylindrical mold. Then, the cylindrical mold was placed into a hot press, and subjected to cold sintering at 400 MPa and 285° C. for 30 min. A resulting ceramic sheet obtained by the cold sintering was annealed at 830° C. for 4 h, and then ground and polished to obtain a borate MWDC.

### Example 4

0.2 mol of B₂O₃ (purity: 98%) and 0.6 mol of CaCO₃ (purity: 99%) were dried separately and placed in a ball. At the same time, zirconia balls (particle size 1.4 mm to 1.6 mm) and absolute ethanol (a mass ratio of a total mass of the B₂O₃ and CaCO₃, the zirconia balls, and the absolute ethanol was 1:3:2.5) were added into the ball mill. Then, the resulting system was subjected to wet ball milling at 400 r/min for 6 h. A resulting slurry was dried in an oven at 80° C. to a constant weight, and sieved through a sieve with a pore size of 80 mesh to collect a sieved material below the sieved. The sieved material was placed into a high-temperature sintering furnace, heated to a temperature of 1,000° C. at 3° C./min, and then subjected to presintering at the temperature for 10 h to obtain a presintered material.

The presintered material, zirconia balls (diameter: 1.4 mm to 1.6 mm), and absolute ethanol (a mass ratio of the presintered material, the zirconia balls, and the absolute ethanol was 1:3:2.5) were placed into a ball mill, and subjected to wet ball milling at 400 r/min for 6 h. A resulting slurry was dried in an oven at 80° C. to a constant weight, and sieved through a sieve with a pore size of 80 mesh to collect a sieved presintered material below the sieve.

5 g of the sieved presintered material and 5 g of a saturated boron oxide solution with a mass concentration of 3.8% were mixed evenly by grinding in a mortar, and a resulting slurry was poured into a cylindrical mold. Then, the cylindrical mold was placed into a hot press, and subjected to cold sintering at 600 MPa and 285° C. for 30 min. A resulting ceramic sheet obtained by the cold sintering was annealed at 840° C. for 3.5 h, and then ground and polished to obtain a borate MWDC.

### Example 5

0.2 mol of B₂O₃ (purity: 98%) and 0.6 mol of CaCO₃ (purity: 99%) were dried separately and placed in a ball mill. At the same time, zirconia balls (particle size 1.4 mm to 1.6 mm) and absolute ethanol (a mass ratio of a total mass of the B₂O₃ and CaCO₃, the zirconia balls, and the absolute ethanol was 1:3:2.5) were added into the ball mill. Then, the resulting system was subjected to wet ball milling at 400 r/min for 6 h. A resulting slurry was dried in an oven at 80° C. to a constant weight, and sieved through a sieve with a pore size of 80 mesh to collect a sieved material below the sieve. The sieved material was placed into a high-temperature sintering furnace, heated to a temperature of 1,000° C. at 3° C./min, and then subjected to presintering at the temperature for 10 h to obtain a presintered material.

The presintered material, zirconia balls (diameter: 1.4 mm to 1.6 mm), and absolute ethanol (a mass ratio of the presintered material, the zirconia balls, and the absolute ethanol was 1:3:2.5) were placed into a ball mill, and subjected to wet ball milling at 400 r/min for 6 h. A resulting slurry was dried in an oven at 80° C. to a constant weight, and sieved through a sieve with a pore size of 80 mesh to collect a sieved presintered material below the sieve.

5 g of the sieved presintered material and 5 g of a saturated boron oxide solution with a mass concentration of 3.8% were mixed evenly by grinding in a mortar, and a resulting slurry was poured into a cylindrical mold. Then, the cylindrical mold was placed into a hot press, and subjected to cold sintering at 800 MPa and 285° C. for 30 min. A resulting ceramic sheet obtained by the cold sintering was annealed at 850° C. for 3 h, and then ground and polished to obtain a borate MWDC.

### Performance Testing

100 MPa refers to Example 1, 200 MPa refers to Example 2, 400 MPa refers to Example 3, 600 MPa refers to Example 4, and 800 MPa refers to Example 5.

### Test Example 1

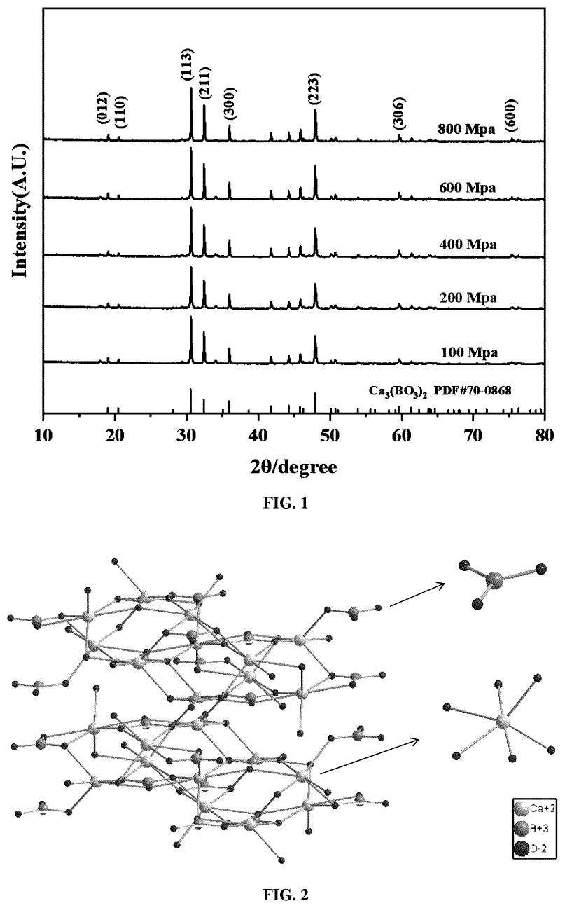

The borate MWDCs obtained in Examples 1 to 5 were subjected to XRD testing, and the obtained XRD patterns are shown in FIG. 1. As shown in FIG. 1, the present disclosure successfully prepares a pure phase Ca₃(BO₃)₂ ceramic through the cold sintering, and no second phase appears. The Ca₃(BO₃)₂ ceramic obtained by the present disclosure belongs to a trigonal crystal system, with a space group of R-3c (No. 167), which is consistent with a PDF #70-0868 card.

FIG. 2 shows a crystal structure of the borate MWDC obtained in Example 5. As shown in FIG. 2, the crystal structure of the ceramic is a layered structure composed of a [CaO₆] octahedron and a [BO₃] planar triangle (where B is located in the center of an equilateral triangle composed of three oxygen atoms). The crystal structure has a unit cell structure where a first layer is formed by three [CaO₆] octahedrons, a second layer is formed by five [CaO₆] octahedrons, and a third layer is formed by three [CaO₆] octahedrons. Each of the layers is connected through shared oxygen atoms at the vertices.

### Test Example 2

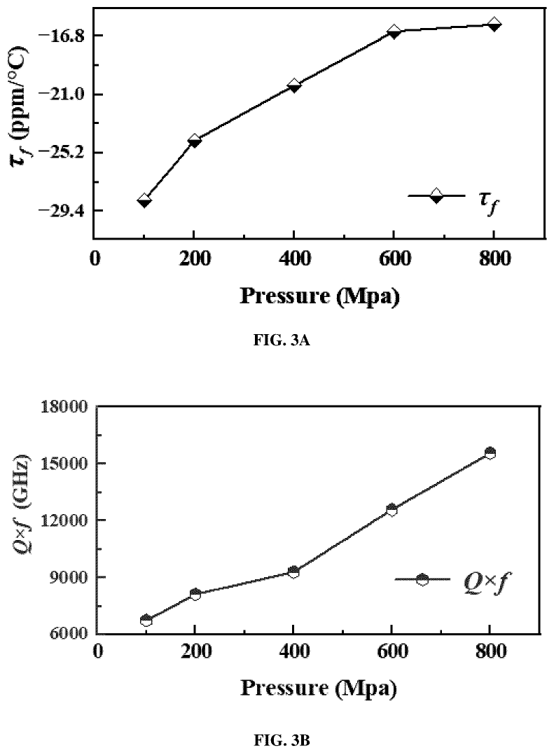

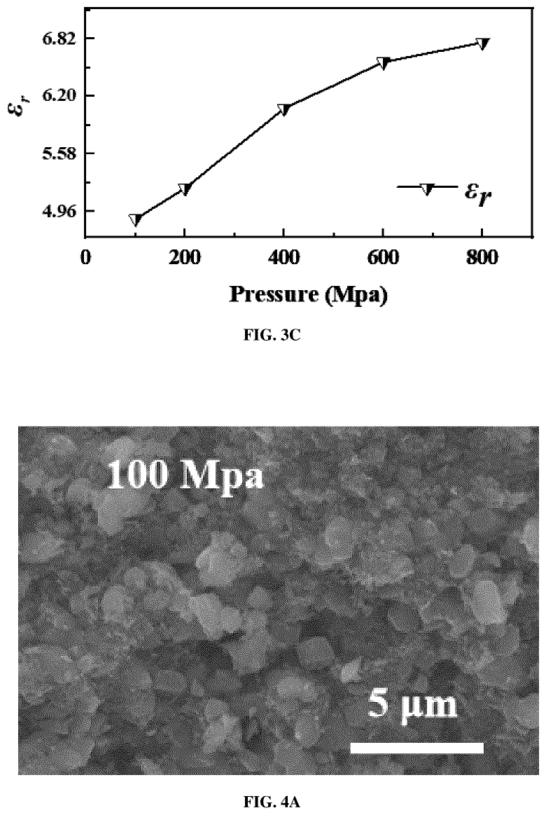

The dielectric properties of the borate MWDCs obtained in Examples 1 to 5 were tested. The test results are shown in FIG. 3A to FIG. 3C and Table 1, where &, represents a dielectric constant, [symbol] ×f represents a quality factor, and τ_{f} represents a temperature coefficient of resonant frequency.

TABLE 1
Dielectric properties of borate
MWDCs obtained in Examples 1 to 5

| | εᵣ | Q × f/GHz | τ_{f}/ppm · ° C.⁻¹ |
|---|---|---|---|
| Example 1 | 4.88 | 6738 | −28.62 |
| Example 2 | 5.21 | 8116 | −24.32 |
| Example 3 | 6.07 | 9291 | −20.35 |
| Example 4 | 6.37 | 12582 | −16.47 |
| Example 5 | 6.58 | 15563 | −15.98 |

As shown in Table 1 and FIG. 3A to FIG. 3C, the borate MWDC obtained by the present disclosure has a dielectric constant of 4.42 to 6.88. As a dielectric material, the borate MWDC could increase a transmission rate of microwave signals in a medium and alleviate signal delay in high-frequency communications. The borate MWDC has a quality factor of 6,737 GHz to 15,563 GHz, showing a high-quality factor while maintaining a low dielectric constant. The borate MWDC has a temperature coefficient of resonant frequency of −28.62 ppm·° C.⁻¹ to −15.98 ppm·° C.⁻¹, which is close to zero. This indicates that the method provided by the present disclosure effectively improves the temperature coefficient of resonant frequency of Ca₃(BO₃)₂ ceramics, and ensures that the Ca₃(BO₃)₂ ceramics have lower resonant frequency drift and more stable performance when the temperature changed greatly.

### Test Example 3

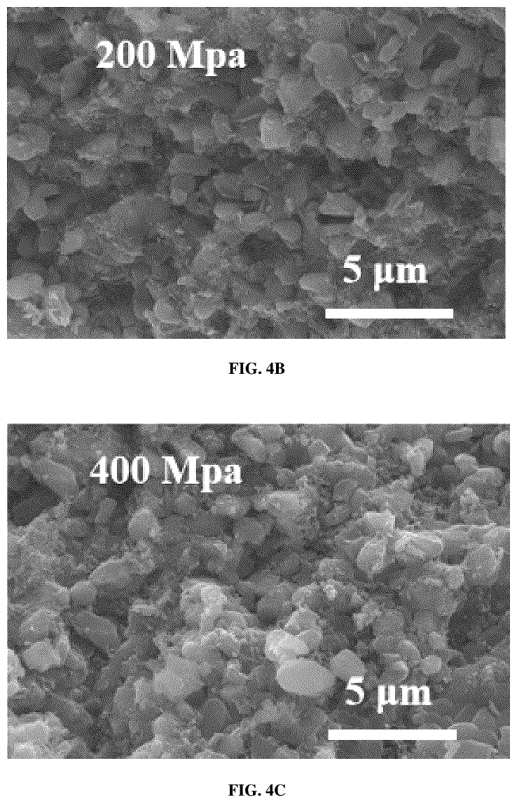

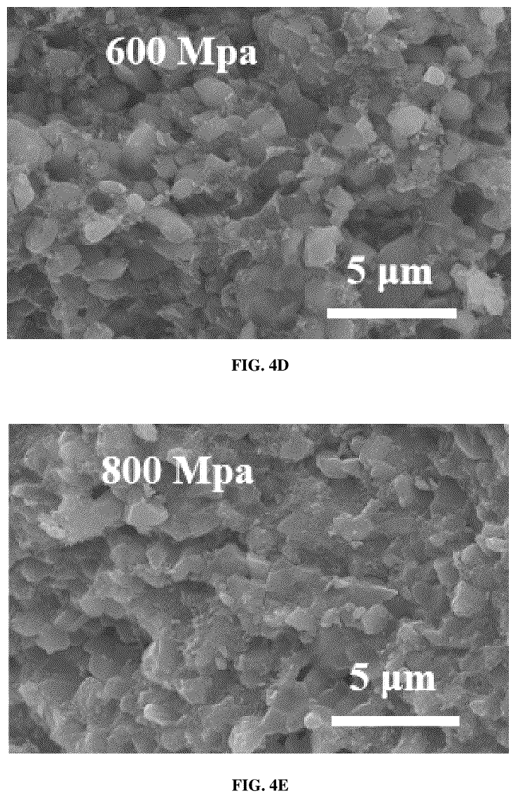

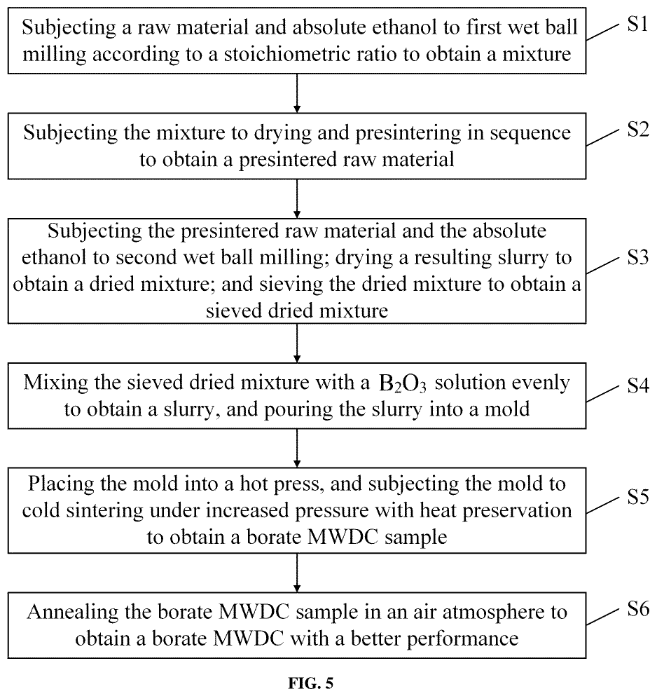

The borate MWDCs obtained in Examples 1 to 5 were subjected to SEM testing, and the obtained SEM images are shown in FIG. 4A to FIG. 4E. FIG. 4A to FIG. 4E show micromorphology of ceramics under different pressures (100 MPa to 800 MPa); where, FIG. 4A shows the micromorphology of ceramics under 100 MPa, FIG. 4B shows the micromorphology of ceramics under 200 MPa, FIG. 4C shows the micromorphology of ceramics under 400 MPa, FIG. 4D shows the micromorphology of ceramics under 600 MPa, and FIG. 4E shows the micromorphology of ceramics under 800 MPa.

As shown in FIG. 4A to FIG. 4E, when the cold sintering is conducted at 100 MPa, the ceramic has more pores, blurred grain boundaries, and a small number of grains. When the cold sintering is conducted at 800 MPa, the ceramic has significantly reduced pores, closer grain arrangement, and denser organizational structure. From this, it can be seen that as the pressure of the cold sintering increased, the Ca₃(BO₃)₂ ceramics has a higher quality factor and better performance.

Although the present disclosure is described in detail in conjunction with the foregoing embodiments, they are only a part of, not all of, the embodiments of the present disclosure. Other embodiments could be obtained based on these embodiments without creative efforts, and all of these embodiments shall fall within the scope of the present disclosure.

What is claimed is:

1. A method for preparing a borate microwave dielectric ceramic (MWDC) with a low dielectric constant by cold sintering, comprising:
subjecting a boron source and a metal source to first mixing to obtain a first mixture, and subjecting the first mixture to presintering to obtain a presintered material; and
subjecting the presintered material and a boron oxide solution to second mixing to obtain a second mixture, and subjecting the second mixture to cold sintering to obtain the borate MWDC with the low dielectric constant.

2. The method of claim 1, wherein the boron source is one or two selected from the group consisting of boron oxide and boric acid; and
a metal element in the metal source is one or more selected from the group consisting of calcium, barium, and strontium.

3. The method of claim 1, wherein a molar ratio of the boron source to the metal source is in a range of 1:2.5 to 1:3.

4. The method of claim 3, wherein the first mixing is conducted by ball milling; and
the ball milling is conducted at a speed of 380 r/min to 400 r/min for 6 h to 8 h.

5. The method of claim 1, wherein the presintering is conducted at a temperature of 1,000° C. to 1,050° C. for 8 h to 10 h.

6. The method of claim 1, wherein the boron oxide solution has a mass concentration of 2.5% to 3.8%; and
a mass ratio of the presintered material to the boron oxide solution is in a range of 1:1 to 2:1.

7. The method of claim 1, further comprising: subjecting the presintered material to wet ball milling, drying, and sieving in sequence before the second mixing;
wherein the wet ball milling is conducted at a speed of 380 r/min to 400 r/min for 6 h to 8 h.

8. The method of claim 1, wherein the cold sintering is conducted at a temperature of 285° C. to 300° C. for 20 min to 30 min under a pressure of 100 MPa to 800 MPa.

9. The method of claim 1, further comprising: after the cold sintering, subjecting a resulting material to annealing;
wherein the annealing is conducted at a temperature of 800° C. to 850° C. for 3 h to 6 h.

10. A borate MWDC with a low dielectric constant prepared by the method of claim 1, wherein the borate MWDC has a dielectric constant of 4.42 to 6.88;
the borate MWDC has a quality factor of 6,737 GHz to 15,563 GHz; and
the borate MWDC has a temperature coefficient of resonance frequency (τ_{f}) of −28.62 ppm· ° C.⁻¹ to −15.98 ppm·° C.⁻¹.

11. The method of claim 2, wherein a molar ratio of the boron source to the metal source is in a range of 1:2.5 to 1:3.

12. The method of claim 8, further comprising: after the cold sintering, subjecting a resulting material to annealing;
wherein the annealing is conducted at a temperature of 800° C. to 850° C. for 3 h to 6 h.

13. The borate MWDC with a low dielectric constant of claim 10, wherein the boron source is one or two selected from the group consisting of boron oxide and boric acid; and
a metal element in the metal source is one or more selected from the group consisting of calcium, barium, and strontium.

14. The borate MWDC with a low dielectric constant of claim 10, wherein a molar ratio of the boron source to the metal source is in a range of 1:2.5 to 1:3.
